(19) United States
(12) Patent Application Publication
(10) Pub. No.: US 2025/0332592 A1
(43) Pub. Date: Oct. 30, 2025

(54) Methods, Systems, and Devices for Rotatable Cartridges

(71) Applicant: IDEXX Laboratories, Inc., Westbrook, ME (US)

(72) Inventor: Michael Schrameyer, Portland, ME (US)

(73) Assignee: IDEXX Laboratories, Inc., Westbrook, ME (US)

(21) Appl. No.: 19/174,035

(22) Filed: Apr. 9, 2025

Related U.S. Application Data
(60) Provisional application No. 63/639,956, filed on Apr. 29, 2024.

(51) Int. Cl. B01L 3/00; B01L 7/00

(52) U.S. Cl. CPC B01L 3/50273; B01L 7/5255; B01L 2200/04; B01L 2200/16; B01L 2300/0654; B01L 2300/0803; B01L 2300/18; B01L 2400/0409

(57) ABSTRACT

A rotatable cartridge for testing a sample includes a sample reservoir at a center of the rotatable cartridge. The rotatable cartridge also includes a plurality of channels extending radially from the sample reservoir, wherein each of the plurality of channels is in fluidic communication with the sample reservoir. The rotatable cartridge additionally includes a reagent reservoir comprising a first barrier separating the reagent reservoir from at least one channel of the plurality of the channels, and wherein displacement of the first barrier allows fluidic communication between the at least one channel and the reagent reservoir. The rotatable cartridge further includes a detection reservoir comprising a second barrier separating the detection reservoir from the reagent reservoir, and wherein displacement of the second barrier allows fluidic communication between the reagent reservoir and the detection reservoir.

### CROSS-REFERENCE TO RELATED APPLICATIONS

This application claims the benefit of U.S. Provisional Patent Application Ser. No. 63/639,956, filed Apr. 29, 2024, which is hereby incorporated by reference in its entirety.

### FIELD OF THE DISCLOSURE

The present disclosure involves testing a biological sample in a rotatable cartridge utilizing centrifugal forces to drive liquid movement.

### BACKGROUND

Centrifugal acceleration created by rotary motion exerts a force on liquid causing it to move radially outward from the axis of rotation. Gravitational acceleration exerts a force on liquid and will cause it to move down an incline. These two physical principles can be used to perform steps involved in diagnostic tests, like chemistry, assay, and polymerase chain reaction (PCR) tests, by manipulating the motion of liquid droplets.

### SUMMARY

In an example, a rotatable cartridge for testing a sample is disclosed. An example for testing a sample. The rotatable cartridge includes a sample reservoir located at a center of the rotatable cartridge. The rotatable cartridge also includes a plurality of channels extending radially from the sample reservoir, wherein each of the plurality of channels is in fluidic communication with the sample reservoir. The rotatable cartridge additionally includes a reagent reservoir comprising a first barrier separating the reagent reservoir from at least one channel of the plurality of the channels, and wherein displacement of the first barrier allows fluidic communication between the at least one channel and the reagent reservoir. The rotatable cartridge further includes a detection reservoir comprising a second barrier separating the detection reservoir from the reagent reservoir, and wherein displacement of the second barrier allows fluidic communication between the reagent reservoir and the detection reservoir.

In another example, a method for testing a sample. The method includes rotating a rotatable cartridge, wherein the rotatable cartridge comprises a sample chamber for receiving the sample, and wherein rotation of the cartridge displaces the sample into a channel extending radially from the sample chamber. The method additionally includes displacing a first barrier between the channel and a reagent reservoir, wherein displacing the first barrier allows fluidic communication between the channel and the reagent reservoir, and wherein the reagent reservoir comprises a reagent. The method further includes displacing a second barrier between the reagent reservoir and a detection reservoir, wherein displacing the second barrier allows fluidic communication between the reagent reservoir and the detection reservoir.

In another example, a system for testing a sample. The system comprising a rotatable cartridge. The rotatable cartridge includes a sample reservoir located at a center of the rotatable cartridge. The rotatable cartridge additionally includes a plurality of channels extending radially from the sample reservoir, wherein each of the plurality of channels is in fluidic communication with the sample reservoir. The rotatable cartridge also includes a reagent reservoir comprising a first barrier separating the reagent reservoir from at least one channel of the plurality of the channels, and wherein displacement of the first barrier allows fluidic communication between the at least one channel and the reagent reservoir. The rotatable cartridge further includes a detection reservoir comprising a second barrier separating the detection reservoir from the reagent reservoir, and wherein displacement of the second barrier allows fluidic communication between the reagent reservoir and the detection reservoir. The system includes an imaging device. The imaging device includes an imaging sensor configured to capture one or more images of the sample in the detection reservoir. The imaging device also includes a computing device configured to analyze the captured one or more images.

The features, functions, and advantages that have been discussed can be achieved independently in various examples or may be combined in yet other examples. Further details of the examples can be seen with reference to the following description and drawings.

### BRIEF DESCRIPTION OF THE FIGURES

The above, as well as additional features will be better understood through the following illustrative and non-limiting detailed description of example embodiments, with reference to the appended drawings.

FIG. 1 illustrates a simplified block diagram of an example computing device, according to an example embodiment.

FIG. 2A illustrates a rotatable cartridge for testing a sample, according to an example embodiment.

FIG. 2B illustrates a rotatable cartridge for testing a sample, according to an example embodiment.

FIG. 2C illustrates a rotatable cartridge for testing a sample, according to an example embodiment.

FIG. 3A illustrates components of a rotatable cartridge in a first position, according to an example embodiment.

FIG. 3B illustrates components of a rotatable cartridge in a second position, according to an example embodiment.

FIG. 3C illustrates components of a rotatable cartridge in a third position, according to an example embodiment.

FIG. 3D illustrates components of a rotatable cartridge in a fourth position, according to an example embodiment.

FIG. 3E illustrates components of a rotatable cartridge in a fifth position, according to an example embodiment.

FIG. 3F illustrates components of a rotatable cartridge in a sixth position, according to an example embodiment.

FIG. 4 illustrates a computing system configured for use with an imaging device and a mobile computing device, according to an example embodiment.

FIG. 5 illustrates a method, according to an example embodiment.

All the figures are schematic, not necessarily to scale, and generally only show parts which are necessary to elucidate example embodiments, wherein other parts may be omitted or merely suggested.

### DETAILED DESCRIPTION

Example embodiments will now be described more fully hereinafter with reference to the accompanying drawings. That which is encompassed by the claims may, however, be embodied in many different forms and should not be construed as limited to the embodiments set forth herein; rather, these embodiments are provided by way of example. Furthermore, like numbers refer to the same or similar elements or components throughout.

Within examples, the present disclosure is directed to devices, systems, and methods for testing a biological sample utilizing a rotatable cartridge.

Testing and/or analyzing, as referred to herein, may include, for example, capturing one or more images related to a sample. For example, testing can involve capturing images of a sample from an imaging sensor and determining a stain intensity. In examples, testing can further involve modifying an intensity of a light source, then capturing one or more additional images from the imaging sensor. One or more machine learning models can then be implemented to analyze the captured images and perform one or more computational actions, including identifying a characteristic of the sample.

In another example, these images may come from competitive immunoassays for detection of antibodies in the sample and a competitive immunoassay may be carried out in the following illustrative manner. A sample (e.g. from an animal's body fluid) potentially containing an antibody of interest that is specific for an antigen, is contacted with the antigen attached to the particle and with the anti-antigen antibody conjugated to a detectable label. The antibody of interest, present in the sample, competes with the antibody conjugated to a detectable label for binding with the antigen attached to the particles. The amount of the label associated with the particles can then be determined after separating unbound antibody and the label. The signal obtained is inversely related to the amount of antibody of interest present in the sample.

In an alternative example embodiment of a competitive immunoassay, a sample (e.g. from an animal's body fluid) potentially containing an analyte, is contacted with the analyte conjugated to a detectable label and with an anti-analyte antibody attached to the particle. The antigen in the sample competes with analyte conjugated to the label for binding to the antibody attached the particle. The amount of the label associated with the particles can then be determined after separating unbound antigen and label. The signal obtained is inversely related to the amount of analyte present in the sample.

Antibodies, antigens, and other binding members (e.g., aptamers) may be attached to the particle or to the label directly via covalent binding with or without a linker or may be attached through a separate pair of binding members as is well known (e.g., biotin: streptavidin, digoxigenin: anti-digoxiginen). In addition, while the examples herein reflect the use of immunoassays, the particles and methods of the disclosure may be used in other receptor binding assays (including nucleic acid hybridization assays) that rely on immobilization of one or more assay components to a solid phase.

In other examples, a sample may be extracted (e.g. from an animal's body fluid) and undergo PCR preparation and testing in order to image and/or otherwise analyze one or more characteristics of the sample. To do so, in example embodiments, the devices, systems, and methods described herein may be used to perform one or more portions of a PCR preparation and testing, including thermocycling to amplify and detect one or more specific target sequences within a sample. In example embodiments, PCR thermocycling may include preparing the extracted sample (e.g., a fecal prepared with clarified lysate) and then establishing multiple temperature zones within various portions of a rotatable cartridge to promote various one or more portions of the PCR preparation. In example embodiments, these multiple temperature zones including a first temperature zone to denature one or more specific target sequences within a sample (e.g., 95 degrees Celsius (° C.)), a second temperature zone to anneal the denatured one or more specific target sequences (e.g., 60° C.), and a third temperature zone to elongate the annealed one or more specific target sequences (e.g., 72° C.). By doing so, in example embodiments, during each temperature cycle of the PCR thermocycling (e.g., 95° C. denature, 60° C. anneal, 72° C. elongate) there can be a doubling of the one or more target sequences, which improves the detection of specific target sequences by improving detection of the one or more target sequences by improving, among other modalities, amplification of the one or more target sequences. In example embodiments, PCR detection may include detection of viruses and/or common infectious pathogens, including diarrhea pathogens.

Typically, centrifugal devices are limited to chemistry tests. These chemistry tests do not require capture, wash, and detection fluids used in more complex tests like immunoassays and PCR. Additionally, some centrifugal devices perform a single test and/or provide a single testing result. Embodiments of the present disclosure provide a rotatable cartridge for a centrifugal device for testing a fluid sample which is configured to perform complex tests, like immunoassays and PCR, by introducing one or more on-board reagents. The rotatable cartridge is also configured to perform multiple tests (e.g., detecting the presence of one more analytes) on a sample simultaneously. The rotatable cartridge utilizes a plurality of channels with respective on-board reagents and detection reservoirs to prepare the sample for and perform multiple tests at once with minimal user interaction. Additionally, the rotatable cartridge, and associated methods, described herein allow for thermocycling of a sample. As described above, thermocycling is a portion of the preparation process in PCR testing.

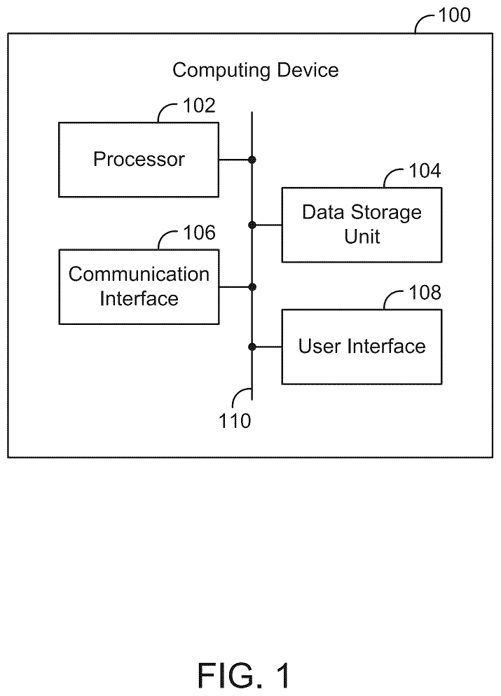

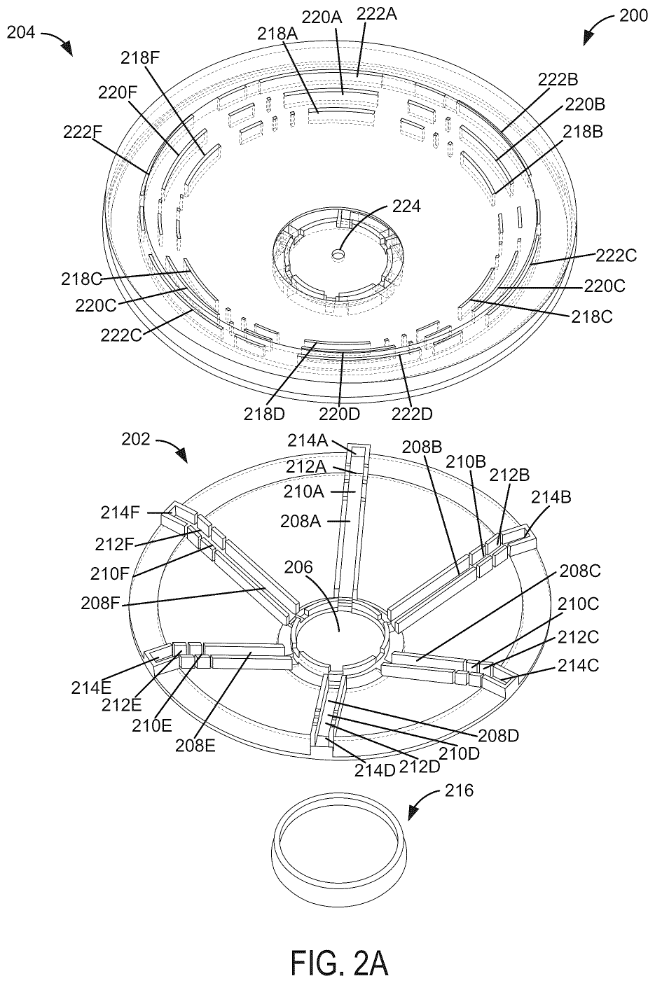

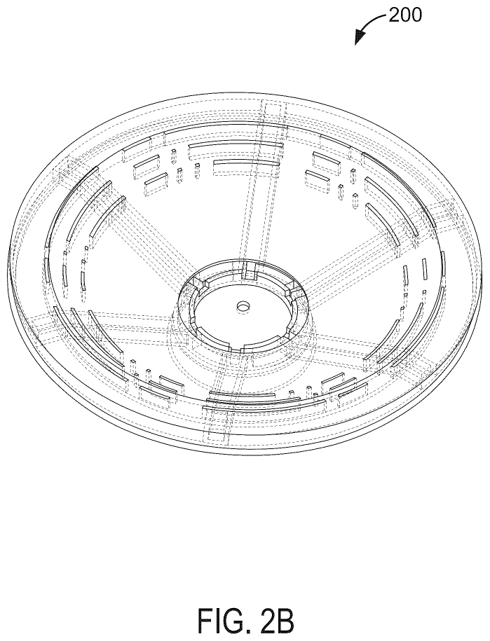

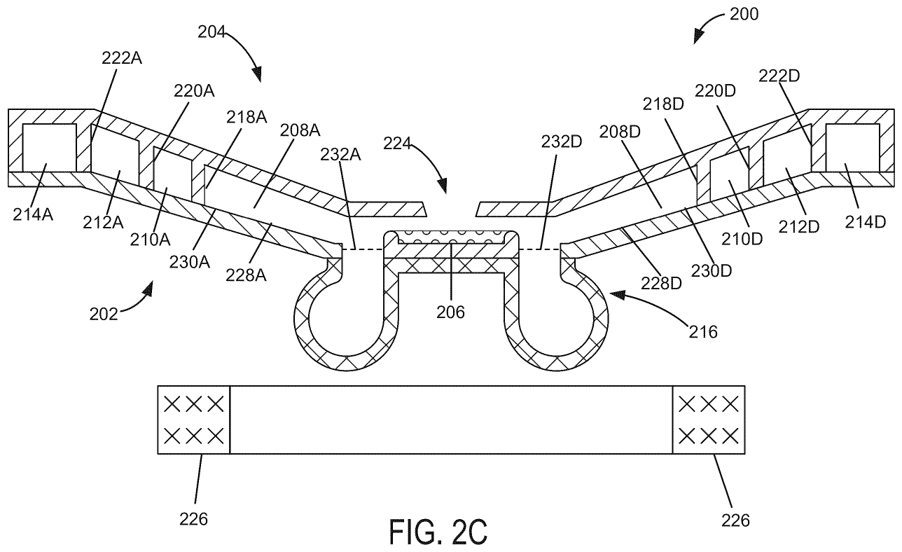

Referring now to the figures, FIG. 1 is a simplified block diagram of an example computing device 100 of a system (e.g., that can be utilized with devices and methods illustrated in FIGS. 2A-4, described in further detail below). Computing device 100 can perform various acts and/or functions, such as those described in this disclosure. Computing device 100 can include various components, such as processor 102, data storage unit 104, communication interface 106, and/or user interface 108. These components can be connected to each other (or to another device, system, or other entity) via connection mechanism 110.

Processor 102 can include a general-purpose processor (e.g., a microprocessor and/or a central processing unit (CPU)) and/or a special-purpose processor (e.g., a digital signal processor (DSP) and/or a graphics processing unit (GPU)).

Data storage unit 104 can include one or more volatile, non-volatile, removable, and/or non-removable storage components, such as magnetic, optical, or flash storage, and/or can be integrated in whole or in part with processor 102. Further, data storage unit 104 can take the form of a non-transitory computer-readable storage medium, having stored thereon program instructions (e.g., compiled or non-compiled program logic and/or machine code) that, when executed by processor 102, cause computing device 100 to perform one or more acts and/or functions, such as those described in this disclosure. As such, computing device 100 can be configured to perform one or more acts and/or functions, such as those described in this disclosure. Such program instructions can define and/or be part of a discrete software application. In some instances, computing device 100 can execute program instructions in response to receiving an input, such as from communication interface 106 and/or user interface 108. Data storage unit 104 can also store other types of data, such as those types described in this disclosure.

Communication interface 106 can allow computing device 100 to connect to and/or communicate with another other entity according to one or more protocols. In one example, communication interface 106 can be a wired interface, such as an Ethernet interface or a high-definition serial-digital-interface (HD-SDI). In another example, communication interface 106 can be a wireless interface, such as a cellular or WI FI interface. In this disclosure, a connection can be a direct connection or an indirect connection, the latter being a connection that passes through and/or traverses one or more entities, such as a router, switcher, or other network device. Likewise, in this disclosure, a transmission can be a direct transmission or an indirect transmission.

User interface 108 can facilitate interaction between computing device 100 and a user of computing device 100, if applicable. As such, user interface 108 can include input components such as a keyboard, a keypad, a mouse, a touch sensitive panel, a microphone, a camera, and/or a movement sensor, all of which can be used to obtain data indicative of an environment of computing device 100, and/or output components such as a display device (which, for example, can be combined with a touch sensitive panel), a sound speaker, and/or a haptic feedback system. More generally, user interface 108 can include hardware and/or software components that facilitate interaction between computing device 100 and the user of the computing device 100.

Computing device 100 can take various forms, such as a workstation terminal, a desktop computer, a laptop, a tablet, a mobile phone, or a controller.

Now referring to FIGS. 2A-2C, a rotatable cartridge 200 for preparing and testing a sample, according to an example embodiment. Namely, FIG. 2A illustrates an exploded view of the rotatable cartridge 200. FIG. 2B illustrates a perspective view of the rotatable cartridge 200. And FIG. 2C illustrates a cross-sectional view of the rotatable cartridge 200.

An example rotatable cartridge 200 includes a bottom plate 202, a top plate 204, and a drain reservoir 216. The bottom plate 202 includes a sample reservoir 206 at a center of the rotatable cartridge 200 configured to receive a sample. A plurality of channels 208A-208F extend radially from the sample reservoir 206. One or more the plurality of channels 208A-208F can include and/or be adjacent to respective reagent reservoirs (e.g., 210A-210F and 212A-212F) and/or respective detection reservoirs (e.g., 214A-214F). Rotation of the rotatable cartridge 200 displaces the sample from the sample reservoir 206 to the channels 208A-208F, the reagent reservoirs (e.g., 210A-210F and 212A-212F), and, ultimately, the detection reservoirs (e.g., 214A-214F) through centrifugal forces.

The top plate 204 is positioned on top of and configured to couple with the bottom plate 202. The top plate 204 includes a series of barriers initially configured to separate the channels and reservoirs from one another. During testing, the top plate 204 can rotate with respect to the bottom plate 202 to sequentially displace the barriers and allow fluidic communications between the channel and the reservoirs. For instance, a barrier between the channel and the reagent reservoir can be displaced to provide fluidic communication between the channel and the reagent reservoir. A barrier between the reagent reservoirs and the detection reservoir can then be displaced to provide fluidic communication between the channel, the reagent reservoirs, and the detection reservoir. This allows the sample to sequentially mix with the reagent and the detection fluids to test (e.g., image) the sample. The barrier can then be repositioned between the reagent reservoir and the detection reservoir to contain the prepared sample for testing and/or imaging. The plurality of channels, reagent reservoirs, and detection reservoirs allows for multiple tests to be performed on a sample at once.

As noted above, the bottom plate 202 includes sample reservoir 206 which, in some examples, is located at the center of the rotatable cartridge 200. The sample reservoir 206 is configured to receive the sample. In some examples, the sample reservoir 206 can include an on-board buffer to prevent pH fluctuations in the sample. Example buffers can include, but are not limited to, Phosphate-buffered saline (PBS), Tris-buffered saline (TBS), Hanks' Balance Salt Solution (HBSS), and/or glycerol-based cryopreservation buffer.

The bottom plate 202 includes a plurality of channels 208A-208F extending radially from the sample reservoir 206. The plurality of channels 208A-208F are in fluidic communication with the sample reservoir 206 so that rotation of the rotatable cartridge 200 displaces the sample from the sample reservoir 206 into the plurality of channels 208A-208F via centrifugal force.

In some examples, one or more of the plurality of channels 208A-208F is inclined (i.e., has a surface on an inclined plane), as shown in FIG. 2C. For instance, the channel can be lower towards the sample reservoir 206 and high towards the reagent reservoir 210A and detection reservoir 214A. In example implementations, centrifugal forces can be used to drive the sample up and down the incline to help facilitate a number of tests. For example, immunoassays may require a back and forth washing motion over magnetically immobilized beads. In these examples, different rotational speeds can be used to iteratively drive the sample up towards the top of the channels 208A-208F and down towards the center of the rotatable cartridge 200. For instance, the sample will be at a lower end of the respective channel (i.e., towards the sample reservoir 206) while the rotatable cartridge 200 rotates at a slower rotational speed. The sample will be at a higher end of the respective channel (i.e., towards the reagent reservoir 210A) while the rotatable cartridge 200 rotates at a faster rotational speed.

Additionally or alternatively, different temperature zones can be created to facilitate thermocycling. As noted above, PCR testing involves thermocycling the sample to promote amplification, and thereby detection, of one or more target sequences in the sample. In example embodiments, performing this thermocycling may be accomplished by configuring various portions of the rotatable cartridge to perform one or more heating functions required for thermocycling the sample. For instance, in some example embodiments denaturation of the sample may occur in a first temperature zone (e.g., at approximately 95° C.), annealing of the sample may occur in a second temperature zone (e.g., at approximately 60° C.), and elongation of the sample may occur in a third temperature zone (e.g., at approximately 72° C.). In some examples, one or more of the first, second, and third temperature zones may be different portions of the rotatable cartridge. In some examples, one or more of the first, second, and third temperature zones may be the same or similar portions of the rotatable cartridge. In the example embodiments illustrated in FIG. 2C shows respective first temperature zones 228A and 228D, respective second temperature zones 230A and 230D, and, although not specifically enumerated in FIG. 2C, the third temperature zones (the elongation temperature zones) would occur also occur in respective first temperature zones 228A and 228D. Other configurations are possible.

In some example embodiments, to achieve a temperature differential (i.e., temperature zones), a heat source (e.g., conductive, radiative, infrared, and/or laser heat sources and/or screen printed conductive inks deposited on an underside of the bottom plate producing resistive heat) can be above or below the rotatable cartridge 200. In examples where the heat source is above the rotatable cartridge 200, the second temperature zone 230A and 230D can be higher than the first temperature zone 228A and 228D. In examples where the heat source is below the rotatable cartridge 200, the first temperature zone 228A and 228D can be at a higher temperature than the second temperature zone 230A and 230D. Different example configurations are possible based on the position of the heat source with respect to the rotatable cartridge 200 and/or temperature zones 228A, 228D, 230A, 230D.

In other examples, different coatings may be used achieve the temperature differential. For instance, the first temperature zone 228A and 228D can include a first coating and the second temperature zone 230A and 230D can include a second coating, different from the first coating.

In examples, the temperature zones correspond to different rotational speeds of the rotatable cartridge 200. For instance, the sample will be at a lower end of the respective channel (i.e., towards the sample reservoir 206) while the rotatable cartridge 200 rotates at a slower rotational speed. The sample will be at a higher end of the respective channel (i.e., towards the reagent reservoir 210A) while the rotatable cartridge 200 rotates at a faster rotational speed. When the rotatable cartridge 200 is rotated a first rotatable speed, the sample is in the first temperature zone 228A and 228D. When the rotatable cartridge 200 is rotated a second rotatable speed, the sample is in the second temperature zone 230A and 230D. The rotatable cartridge 200 can iteratively rotate at these different speeds to allow temperature cycling (e.g., 30-40 times). In some examples, the channels can include three temperature zones. In these examples, the temperature zones may correspond to the different phases of PCR testing (i.e., denaturation, annealing, and elongation).

In some examples, the one or more channels 208A-208F can include a plurality of beads (e.g., one or more types of paramagnetic, bar-coded beads). The plurality of beads can be adhered to a surface of one or more of the plurality of channels 208A-208F. The plurality of beads can contain one or more identifying features (such as a unique bar code, a responsive wavelength, a color, a shape, an alphanumeric symbol, and/or the like) that can be detected independent of a signal associated with the presence of analyte. By utilizing the plurality of independently-detectable beads, a user can perform multiple tests at once to detect a number of different analytes.

In example embodiments, the plurality of channels 208A-208F include and/or are adjacent to one or more reagent reservoirs. In some examples, each of the plurality of channels 208A-208F is adjacent to a corresponding first reagent reservoir 210A-210F. Additionally, in some examples, the first reagent reservoir 210A-210F can be adjacent to a respective second reagent reservoir 212A-212F. Each reagent reservoir can include one or more on-board reagents to prepare the sample for testing. In examples, the reagents can include one or more of: (i) a binding reagent; (ii) a wash reagent; (iii) a conjugate reagent; (iv) a fluorescent stain; (v) markers; (vi) transport (e.g., oil); (vii) or beads. In examples, the first reagent reservoirs 210A-210F can include a binding reagent and the second reagent reservoirs 212A-212F can include a wash reagent, or vis versa. Many example combinations of reagents are possible.

In example embodiments, the different reagent reservoirs can include different on-board reagents suitable for performing different tests on the sample at once. For instance, different reagent reservoirs can include different reagents to prepare the sample to be tested for analytes that can be detected in samples as a result of a binding assay, typically an immunoassay. Example tests can include the determination of a vast variety of analytes know in the art to be detectable by, for example, immunoassay, including, but are not limited to: (i) PCR, (ii) Anaplasma, (iii) Ehrilichia, (iv) heartworm, (v) Lyme disease, (vi) Feline Immunodeficiency Virus (FIV), (vii) Feline leukemia virus (FeLV), (viii) Giardia, (ix) Parvo, (x) Lepto, (xi) hookworm, (xii) roundworm, (xiii) whipworm, (xiv) tapeworm, (xv) cystoisospora, (xvi) campylobacter jejuni, (xvii) cryptosporidium, (xviii) enteric coronavirus, (xix) salmonella, or (xx) tritrichromonas. In an example implementation, reagent reservoirs 210A and 212A include reagents suitable for an Anaplasma test, reagent reservoirs 210B and 212B include reagents suitable for an Ehrilichia test, reagent reservoirs 210C and 212C include reagents suitable for a heartworm test, reagent reservoirs 210D and 212D include reagents suitable for a Lyme disease test, reagent reservoirs 210E and 212E include reagents suitable for a FIV test, and reagent reservoirs 210F and 212F include reagents suitable for a FELV test. In example embodiments, PCR detection may include detection of common infectious pathogens, including diarrhea pathogens: (1) Parvovirus/Panleukopenia; (2) Campylobacter jejuni; (3) Cryptosporidium spp.; (4) Enteric Coronavirus; (5) Giardia spp.; (6) Salmonella spp.; and (7) Tritrichomonas blagburni, among others. Many example combinations of tests are possible.

Although the example rotatable cartridge 200 shown in FIGS. 2A-2C, includes 6 channels 208A-208F, 6 first reagent reservoirs 210A-210F, and 6 second reagent reservoirs 212A-212F, many different configurations are possible. For instance, in some examples, the rotatable cartridge 200 may include fewer channels (e.g., 1, 2, 3, 4, or 5). Alternatively, in some examples, the rotatable cartridge 200 can include more channels (7, 8, 9, 10, etc.).

In some example implementations, each channel 208A-208F has a respective first reagent reservoir 210A-210F and a respective second reagent reservoir 210A-210F. Alternatively, in some examples, some channels (e.g., 208A-208C) have 2 respective reagent reservoirs (e.g., 210A-210C and 212A-212C) and the remaining channels (e.g., 208D-208F) have 1 respective reagent reservoir (e.g., 210D-210F). In other examples, some channels (e.g., 208A-208B) may have 2 respective reagent reservoirs (e.g., 210A-210B and 212A-212B), some channels (e.g., 208C-208D) may have 1 respective reagent reservoir (e.g., 210C-210D), and the remaining channels (e.g., 208E-208F) may not have a respective reagent reservoir. In another example, one or more of the channels 208A-208F can have 3 more respective reagent reservoirs. Many example combinations and configurations of channels reagent reservoirs are possible.

The bottom plate includes a detection reservoir 214A-214F for each channel 208A-208F. In examples, the detection reservoirs 214A-214F are near the perimeter of the rotatable cartridge 200 so that the sample can travel through the channels and reagent reservoirs before reaching the detection reservoirs. Additionally, the rotatable cartridge 200 will likely be at or near the fastest rotational speed for the sample to reach the detection reservoir 214A-214F.

In example implementations, the detection reservoirs 214A-214F include one or more on-board detection fluids. In some examples, the detection fluid can include, but is not limited to one more fluorescent stains, Tetramethylbenzidine (TMB), fluorescein (FAM), Tetramethylrhodamine (TAMRA), Hexachlorofluorescein (HEX), Jun proto-oncogene (JUN), Cyanine Dye 5 (Cy5), and Cyanine Dye 5.5 (Cy5.5).

In examples, the detection reservoirs 214A-214F include a plurality of particles, such as beads. The plurality beads can be adhered to a surface of the detection reservoirs 214A-214F to keep them in the focal plane for viewing. The plurality of beads can contain one or more identifying features (such as a unique bar code, a responsive wavelength, a color, a shape, an alphanumeric symbol, and/or the like) that can be detected independent of a signal associated with the presence of analyte. By utilizing the plurality of independently-detectable beads, the rotatable cartridge 200 can perform multiple tests at once to detect a number of different analytes.

In examples where different tests are being performed on the sample at once, the detection reservoir can include detection fluid suitable for the corresponding test. For example, if reagent reservoirs 210A and 212B include reagents suitable to prepare the sample for a heartworm test, detection reservoir 214A can include a detection fluid suitable for a heartworm test. And, if reagent reservoirs 210B and 212B include reagents suitable to prepare the sample for an Anaplasma test, detection reservoir 214B can include detection fluid suitable for an Anaplasma test. Many examples are possible.

In example embodiments, the plurality of detection reservoirs 214A-214F have a flat surface, rather than inclined surface like the channels and reagent reservoirs. The flat surface helps to facilitate retaining the sample, such that once the sample reaches the detection reservoir 214A-214F, it does not flow back down the channels 2018A-208F into the drain reservoir 216. Further, once the sample is prepared and the rotatable cartridge 200 is no longer rotating, the sample can be imaged in the detection reservoir 214A-214F. A flat surface helps to distribute the sample in an even layer (e.g., having a consistent depth) across the detection reservoir 214A-214F. Additionally, in example implementations, the detection reservoirs 214A-214F can include optically transparent materials suitable for imaging and/or observation.

In some examples, there may be a visual indication of a testing result. For instance, the detection fluid may turn a certain color to indicate a positive result or negative testing result of a particular test. In another example, a visual indication may not be detectable to the human eye, such as a fluorescent stain. In these examples, a user may utilize an imaging device and/or an optical reader to help determine a testing result. Many examples are possible as are known in the immunoassay arts.

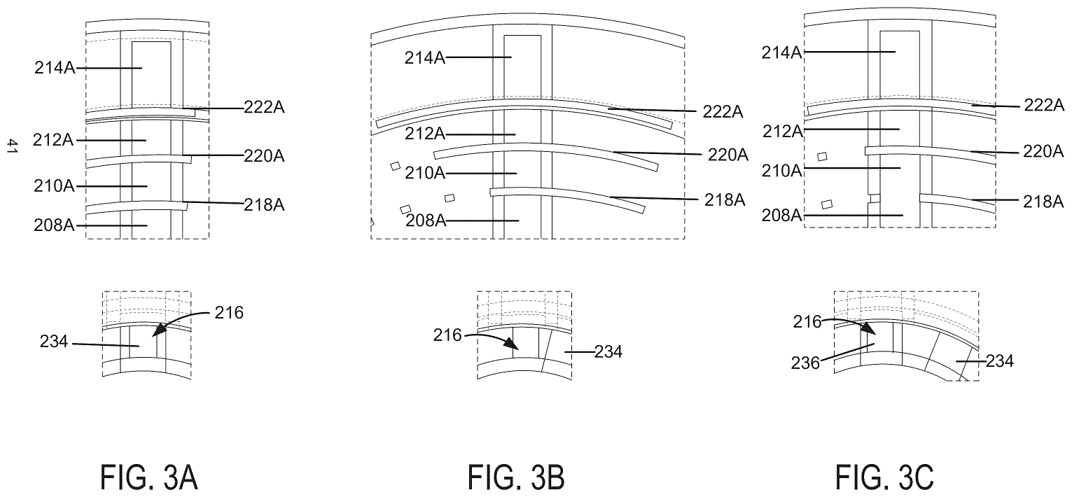

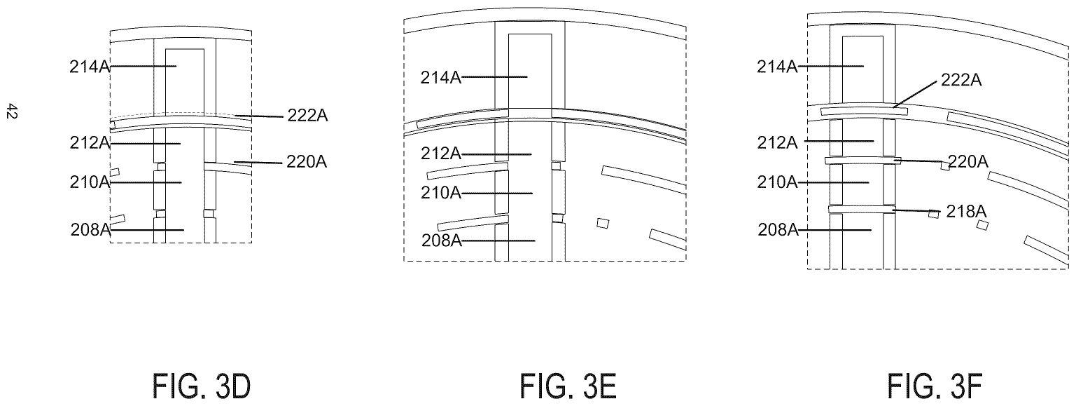

The top plate 204 is configured to removably couple to the bottom plate 202. The top plate 204 includes a series of barriers corresponding to the series of reservoirs in the bottom plate 202. Namely, the series of barriers in the top plate 204 are configured to separate (e.g., prevent fluidic communication between) respective reservoirs and/or channels during different portions of preparing the sample for testing. In example embodiments, the walls of the channels 208A-208F have gaps to receive and allow movement of the barriers. In this manner, the respective reagents and detection fluids can be introduced to the sample in a sequential manner. The top plate 204 rotates independently of the bottom plate 202 (i.e., the top plate 204 can vary in position with respect to the bottom plate 202) to displace the barriers. Specific positions of the top plate 204 and displacing the barriers is shown in FIGS. 3A-3F and described in the corresponding paragraphs.

In example embodiments, the top plate 204 can include barriers 218A-218F to separate the plurality of channels 208A-208F from the first reagent reservoirs 210A-210F. Displacement of barriers 218A-218F allows fluidic communication between the channels 208A-208F and the first reagent reservoirs 210A-210F.

In example embodiments, the top plate 204 can include barriers 220A-220F to separate the first reagent reservoirs 210A-210F from the second reagent reservoirs 212A-212F. Displacement of barriers 220A-22OF allows fluidic communication between the first reagent reservoirs 210A-210F and the second reagent reservoirs 212A-212F. Additionally, displacement of barriers 218A-218F and barriers 220A-22OF allows fluidic communication between the channels 208A-208F and the second reagent reservoirs 212A-212F.

In example embodiments, the top plate 204 can include barriers 222A-222F to separate the second reagent reservoirs 212A-212F from the detection reservoirs 214A-214B. Displacement of barriers 222A-222F allows fluidic communication between the second reagent reservoirs 212A-212F and the detection reservoirs 214A-214F. Additionally, displacement of barriers 218A-218F, barriers 220A-220F, and barriers 222A-222F allows fluidic communication between the channels 208A-208F, the first reagent reservoirs 212A-212F, the second reagent reservoirs 212A-212F, and the detection reservoirs 214A-214F. Once the sample is prepared, barriers 222A-222F can be repositioned between the second reagent reservoirs 212A-212F from the detection reservoirs 214A-214B to contain the prepared sample within the detection reservoirs 214A-214F during testing and/or imaging.

In example embodiments, the top plate 204 additionally includes an inlet port 224. The inlet port 224 is positioned above the sample reservoir 206 allowing a user to deposit the sample into the sample reservoir 206. In some examples, the inlet port 224 has a small diameter to prevent loss of the sample as the rotatable cartridge 200 rotates.

In example embodiments, the rotatable cartridge 200 can include a drain reservoir 216 coupled to a bottom surface of bottom plate 202. In some examples, there is a gap and/or aperture between the sample reservoir 206 and the plurality of channels 208A-208F allowing excess sample to be collected in the drain reservoir 216.

In some examples, to prepare the sample, the rotatable cartridge 200 is rotated at a rotational speed fast enough to displace the sample from the sample reservoir 206 to the plurality of channels 208A-208F, bypassing the drain reservoir 216. Once the sample is prepared, the rotatable cartridge 200 stops or slows rotation, and, in some examples, the barriers 222A-222F are repositioned to retain the sample, excess sample can drain into the drain reservoir 216. Additionally or alternatively, the rotatable cartridge 200 can include a barrier above the drain reservoir 216, which allows opening and closing the drain reservoir 216, as desired, during certain stages of preparing and testing the sample.

In some example embodiments, the rotatable cartridge 200 can include time delay tape (e.g., 232A and 232D). In these examples, the time delay tape can dissolve after a period of time. This prevents the sample from draining into the drain reservoir 216 before the sample has been prepared and/or is retained in the detection reservoir 214A-214F.

In some example implementations, one or more magnets 226 can be placed below the rotatable cartridge 200 during preparation, testing, and/or imaging of the sample. In some examples, magnet 226 is a ring magnet. In other examples, magnet 226 can include a plurality of magnets. In examples where one or more the detection reservoirs 214A-214F and/or one or more of the channels 208A-208F includes beads (e.g., magnetic beads), the magnet 226 helps hold the beads in place (i.e., prevent the beads from moving to the outer perimeter) during rotation of the rotatable cartridge 200.

A computing device, such as computing device 100, can include instructions to rotate the rotatable cartridge 200 at a series of rotational speeds, as desired for the type of tests and/or sample and various stages of preparing and testing the sample. For instance, the computing device 100 can provide instructions to vary the rotational speed of the rotatable cartridge 200 to allow for thermocycling.

Now referring to FIGS. 3A-3C. FIGS. 3A-3F illustrate an example series of positions of the top plate 204 with respect to the bottom plate 202 and the drain reservoir 216. Namely, FIGS. 3A-3F illustrate sequential displacement of barriers to prepare and test the sample.

FIG. 3A illustrates a first position for a first stage of preparing the sample. In this first position, the barriers are separating all the on-board reagents from the sample. Namely, barrier 218A is positioned between the channel 208A and the first reagent reservoir 210A. Barrier 220A is positioned between the first reagent reservoir 210A and the second reagent reservoir 212A. And barrier 222A is positioned between the second reagent reservoir 212A and the detection reservoir 214A. Additionally, a barrier 234 may be positioned over the drain reservoir 216 to allow the sample to travel from the sample well into the channel 208A. In example implementation, the sample can undergo thermocycling while the rotatable cartridge 200 is in the first position.

FIG. 3B illustrates a second position for a second stage of preparing the sample. In this second position, the barriers are separating all the on-board reagents from the sample, same as they are in the first position. In this second position, barrier 234 is displaced from above the drain reservoir 216 to allow spent sample to drain from the channel 208A.

FIG. 3C illustrates a third position for a third stage of preparing the sample. In this third position, barrier 218A is displaced to allow a fluidic communication between the channel 208A and the first reagent reservoir 210A. This allows the sample to mix with the first on-board reagent. In this third position, barrier 220A is positioned between the first reagent reservoir 210A and the second reagent reservoir 212A. And barrier 222A is positioned between the second reagent reservoir 212A and the detection reservoir 214A. Additionally, a barrier 236 may be positioned over the drain reservoir 216 to prevent loss of the sample during preparation. In examples, the barrier 236 may be positioned over the drain reservoir 216 for the remainder of the preparation process.

FIG. 3D illustrates a fourth position for a fourth stage of preparing the sample. In this fourth position, barrier 220A is displaced to allow a fluidic communication between the channel 208A, the first reagent reservoir 210A, and the second reagent reservoir 212A. This allows the sample to mix with the second on-board reagent. In this fourth position, barrier 222A is positioned between the second reagent reservoir 212A and the detection reservoir 214A.

FIG. 3E illustrates a fifth position for a fifth stage of preparing the sample. In this fifth position, barrier 220A is displaced to allow a fluidic communication between the channel 208A, the first reagent reservoir 210A, the second reagent reservoir 212A, and the detection reservoir 214A. This allows the prepared sample to flow into the detection reservoir 214A and mix with the detection fluid. In some example implementations, the rotational speed of the rotatable cartridge 200 can be increased to facilitate this.

FIG. 3F illustrates a sixth position for a sixth stage of preparing the sample. In this sixth position, barrier 222A is repositioned between the detection reservoir 214A and the second reagent reservoir 212A to retain the prepared sample for testing and/or imaging. In some examples, barrier 220A is repositioned between the first reagent reservoir 210A and the second reagent reservoir 212A. And barrier 222A is repositioned between the second reagent reservoir 212A and the detection reservoir 214A. Additionally, in some example implementations, the drain reservoir 216 may be opened (e.g., barriers removed from above the drain) to drain any excess or spent sample.

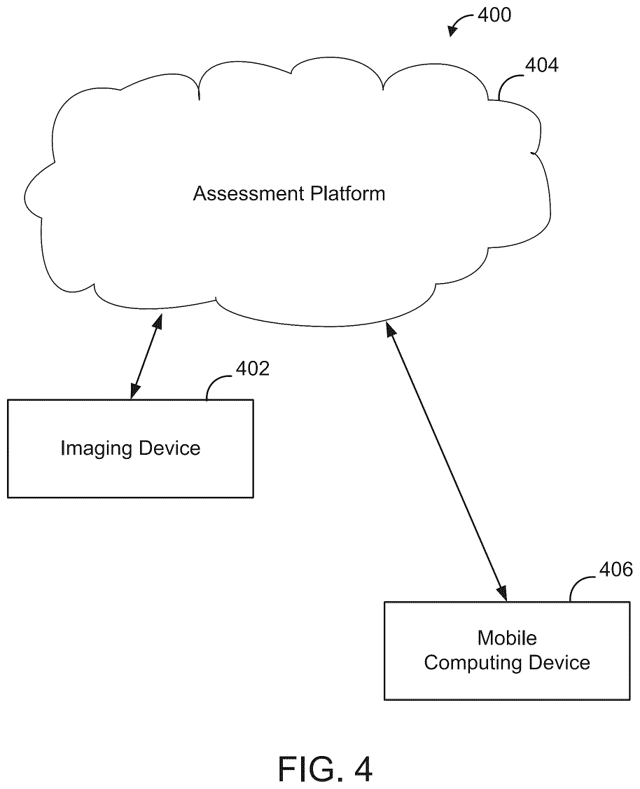

Now referring to FIG. 4, a computing system 400 configured for use with an imaging device 402 and a mobile computing device 406, according to an example embodiment. Example cartridges (e.g., rotatable cartridge 200) are compatible with an imaging device 402 that can read an optical signal present on a cartridge. Signals may include a color or intensity of light associated with the cartridge or may detect an image present on the cartridge that is associated with a bead (e.g., barcoded, shape, size, etc.) present in the cartridge. An imaging device 402 includes a computing device, such as computing device 100. It should also be readily understood that computing device 100 and the imaging device 402, and all of the components thereof, can be physical systems made up of physical devices, cloud-based systems made up of cloud-based devices that store program logic and/or data of cloud-based applications and/or services (e.g., perform at least one function of a software application or an application platform for computing systems and devices detailed herein), or some combination of the two.

In any event, a computing system 400 can include various components, such as the computing device 100, imaging device 402, a cloud-based assessment platform.

The imaging device 402 and/or components thereof can perform various acts and/or functions (many of which are described above). Examples of these and related features will now be described in further detail.

The imaging device 402 may collect data from a number of sources. In one example, the imaging device 402 may collect data from a database of images related to testing of samples, including one or more images of the sample and/or cartridge. The images may be uploaded to an assessment platform 404 and characteristics of the images may be output to a mobile computing device 406.

In an example, assessment platform 404 may collect data from one or more sensors communicably coupled to the imaging device 402, such as an imaging sensor, concerning a particular sample. In such examples, the assessment platform 404 may identify a characteristic of the sample or a testing result and transmit instructions to the mobile computing device 406 to cause a graphical user interface to display a graphical indication of the identified characteristic and/or testing result. In some examples, the assessment platform 404 may determine a testing result by utilizing one or more of: (i) an artificial neural network, (ii) a support vector machine, (iii) a regression tree, or (iv) an ensemble of regression trees.

In another example, the imaging device 402 may collect data from one or more sensors communicably coupled to the imaging device, such as an imaging sensor, concerning a particular sample and/or cartridge. In some examples, the assessment platform 404 may determine a characteristic of the sample and/or testing result by utilizing one or more of: (i) an artificial neural network, (ii) a support vector machine, (iii) a regression tree, or (iv) an ensemble of regression trees.

In some examples, images that are captured by the imaging device can be stored within a memory, such as a memory of computing device 100, to be subsequently analyzed.

In one example, the imaging device 402 may train a machine learning model using data associated images of sample and/or cartridge that share a characteristic with captured images of samples and/or cartridges. The machine learning model may be trained using training data that shares a characteristic and/or testing result with samples and/or cartridges to be analyzed by the imaging device. Training the machine learning model may include inputting one or more training images into the machine learning model, predicting, by the machine learning model, an outcome of a determined condition of the one or more training images, comparing the at least one outcome to the characteristic of the one or more training images, and adjusting, based on the comparison, the machine learning model.

In some examples, the training data may include labeled input images (supervised learning), partially labeled input images (semi-supervised learning), or unlabeled input images (unsupervised learning). In some examples, training may include reinforcement learning.

The machine learning model may include an artificial neural network, a support vector machine, a regression tree, an ensemble of regression trees, or some other machine learning model architecture or combination of architectures.

In some examples, the machine learning model of the imaging device 402 may be adjusted based on training such that if the outcome of a determined testing result matches the characteristic and/or testing result of the training images, the machine learning model is reinforced and if the outcome of a determined testing result does not match the characteristic of the training images, the machine learning model is modified. In some examples, modifying the machine learning model includes increasing or decreasing a weight of a factor within the neural network of the machine learning model. In other examples, modifying the machine learning model includes adding or subtracting rules during the training of the machine learning model.

Once the imaging device 402 has determined a characteristic of a sample in one or more images, the imaging device may transmit instructions that cause a computing device (e.g., the computing device 100) to display one or more graphical indications of the identified characteristic and/or the enhanced image.

In some example embodiments, the sample can be used for a variety of tests. For instance, these tests may include imaging of one or more of the following: (i) blood; (ii) urine; (iii) saliva; (iv) fecal matter; (v) secretion; (vi) excretion; (vii) FNA; (viii) lavage fluids; (ix) body cavity fluids; (x) semen; (xi) ear wax; (xii) skin cells; (xiii) biopsied samples, (xiv) exotics; (xv) cultured cells; (xvi) bacteria; (xvii) worms; (xviii) parasites; and (xix) ear mites, among other possibilities. Test may additionally include one or more of the following: blood coagulation test, polymerase chain reaction (PCR) test, and/or immunoassay, among other possibilities. For example, in some example embodiments, these tests may include one or more of the following blood chemistry tests: SDMA, Total T4 (TT4), Bile Acids, C-reactive Protein (CRP), Progesterone, Fructosamine, and/or Phenobarbital (PHBR), among other possibilities. For example, in some example embodiments, these tests may include one or more of the following blood chemistry profile tests that measure one or more of the following: ALB, ALB/GLOB, ALKP, ALT, AMYL, AST, BUN, BUN/CREA, Ca, CHOL, CK, CI, CREA, CRP, FRU, GGT, GLOB, GLU, K, LAC, LDH, LIPA, Mg, Na, NH₃, PHOS, TBIL, TP, TRIG and/or URIC, among other possibilities. Other examples are possible.

### EXAMPLE METHODS AND ASPECTS

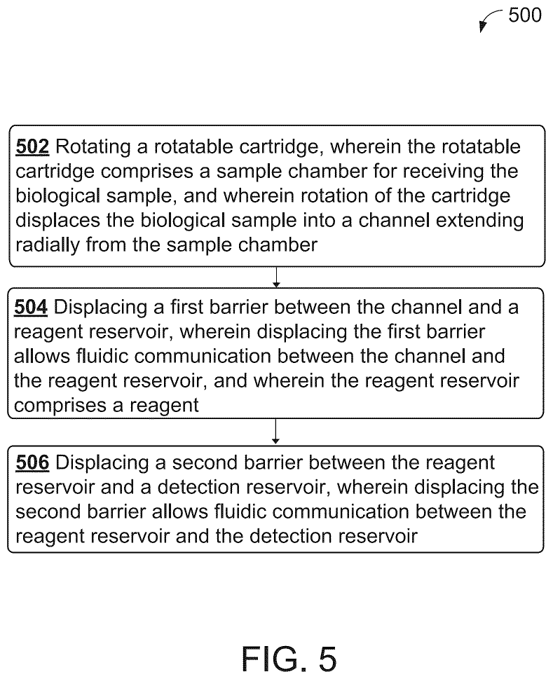

Now referring to FIG. 5, an example method of preparing a biological testing sample is disclosed. Method 500 shown in FIG. 5 presents an example of a method for preparing a biological testing sample that could be used with the components shown in FIGS. 2A-3F, for example. Further, devices or systems may be used or configured to perform logical functions presented in FIG. 5. In other examples, components of the devices and/or systems may be arranged to be adapted to, capable of, or suited for performing the functions, such as when operated in a specific manner. Method 500 may include one or more operations, functions, or actions as illustrated by one or more of blocks 502-506. Although the blocks are illustrated in a sequential order, these blocks may also be performed in parallel, and/or in a different order than those described herein. Also, the various blocks may be combined into fewer blocks, divided into additional blocks, and/or removed based upon the desired implementation.

At block 502, method 500 involves rotating a rotatable cartridge, wherein the rotatable cartridge comprises a sample chamber for receiving the sample, and wherein rotation of the cartridge displaces the sample into a channel extending radially from the sample chamber.

At block 504, method 500 involves displacing a first barrier between the channel and a reagent reservoir, wherein displacing the first barrier allows fluidic communication between the channel and the reagent reservoir, and wherein the reagent reservoir comprises a reagent.

At block 506, method 500 involves displacing a second barrier between the reagent reservoir and a detection reservoir, wherein displacing the second barrier allows fluidic communication between the reagent reservoir and the detection reservoir.

In some examples, the channel, the reagent reservoir, and the detection reservoir are coupled to a bottom plate. In these examples, the first barrier and the second barrier are coupled to a top plate, the top plate positioned above the bottom plate. In these examples, displacing the first barrier comprises rotating the top plate from a first position to a second position with respect the bottom plate. And displacing the second barrier comprises rotating the top plate from the second position to a third position with respect to the bottom plate.

In some examples, the channel comprises a first temperature zone and second temperature zone. In these examples, rotating the cartridge at a first rotational speed displaces the sample into the first temperature zone. And rotating the cartridge at the second rotational speed displaces the sample to the second temperature zone.

Various aspects and embodiments have been disclosed herein, but other aspects and embodiments will certainly be apparent to those skilled in the art. Additionally, the various aspects and embodiments disclosed herein are provided for explanatory purposes and are not intended to be limiting, with the true scope being indicated by the following claims.

What is claimed is:

1. A rotatable cartridge for testing a sample, wherein the rotatable cartridge comprises:
a sample reservoir located at a center of the rotatable cartridge;
a plurality of channels extending radially from the sample reservoir, wherein each of the plurality of channels is in fluidic communication with the sample reservoir;
a reagent reservoir comprising a first barrier separating the reagent reservoir from at least one channel of the plurality of the channels wherein displacement of the first barrier allows fluidic communication between the at least one channel and the reagent reservoir; and
a detection reservoir comprising a second barrier separating the detection reservoir from the reagent reservoir wherein displacement of the second barrier allows fluidic communication between the reagent reservoir and the detection reservoir.

2. The rotatable cartridge of claim 1, wherein rotation of the rotatable cartridge at a first rotational speed displaces the sample from the sample reservoir into the plurality of channels.

3. The rotatable cartridge of claim 2, wherein, when the first barrier is displaced, rotation of the rotatable cartridge at a second rotational speed displaces the sample into the reagent reservoir.

4. The rotatable cartridge of claim 3, wherein, when the second barrier is displaced, rotation of the rotatable cartridge at a third rotational speed, displaces the sample into the detection reservoir.

5. The rotatable cartridge of claim 4, wherein the second rotational speed is faster than the first rotational speed, and wherein the third rotational speed is faster than the second rotational speed.

6. The rotatable cartridge of claim 1,
wherein the plurality of channels, the reagent reservoir, and the detection reservoir are coupled to a bottom plate; and
wherein the first barrier and the second barrier are coupled to a top plate, the top plate positioned above the bottom plate.

7. The rotatable cartridge of claim 6, having at least three positions with respect to each other
wherein, when the top plate and the bottom plate are in a first position with respect to each other, the first barrier separates the at least one channel and the reagent reservoir;
wherein, when the top plate and the bottom plate are in a second position with respect to each other, (i) the first barrier is displaced allowing the fluidic communication between the channel and the reagent reservoir, and (ii) the second barrier separates the reagent reservoir with the detection reservoir; and
wherein, when the top plate and the bottom plate are in a third position with respect to each other, the second barrier is displaced allowing the fluidic communication between the reagent reservoir and the detection reservoir.

8. The rotatable cartridge of claim 1, wherein each channel of the plurality of channels comprises a respective reagent reservoir and a respective detection reservoir.

9. The rotatable cartridge of claim 8,
wherein the channel comprises a first temperature zone and a second temperature zone,
wherein rotation of the rotatable cartridge at a first rotational speed displaces the sample to the first temperature zone, and
wherein rotation of the rotatable cartridge at a second rotational speed displaces the sample to the second temperature zone.

10. The rotatable cartridge of claim 1, wherein the sample reservoir comprises a buffer.

11. The rotatable cartridge of claim 1, wherein at least one of the plurality of channels comprises an incline surface.

12. The rotatable cartridge of claim 1, wherein at least one of the plurality of channels comprises beads on a surface of the at least one channel.

13. The rotatable cartridge of claim 1, wherein the reagent reservoir comprises one or more of:
(i) a binding reagent; (ii) a wash reagent; (iii) a conjugate reagent; (iv) a fluorescent stain; (v) markers; (vi) transport; or (vii) beads.

14. The rotatable cartridge of claim 1, wherein the detection reservoir comprises a detection fluid.

15. The rotatable cartridge of claim 1, wherein the detection reservoir comprises optically transparent material.

16. The rotatable cartridge of claim 1, further comprising a drain reservoir adjacent to the sample reservoir.

17. A method for testing a sample, the method comprising:
rotating a rotatable cartridge, wherein the rotatable cartridge comprises a sample reservoir for receiving the sample, and wherein rotating the rotatable cartridge displaces the sample into a channel extending radially from the sample reservoir;
displacing a first barrier between the channel and a reagent reservoir, wherein displacing the first barrier allows fluidic communication between the channel and the reagent reservoir, and wherein the reagent reservoir comprises a reagent; and
displacing a second barrier between the reagent reservoir and a detection reservoir, wherein displacing the second barrier allows fluidic communication between the reagent reservoir and the detection reservoir.

18. The method of claim 17,
wherein the channel, the reagent reservoir, and the detection reservoir are coupled to a bottom plate,
wherein the first barrier and the second barrier are coupled to a top plate, the top plate positioned above the bottom plate,
wherein displacing the first barrier comprises rotating the top plate from a first position to a second position with respect the bottom plate, and
wherein displacing the second barrier comprises rotating the top plate from the second position to a third position with respect to the bottom plate.

19. The method of claim 17, wherein the channel comprises a first temperature zone and second temperature zone, and
wherein rotating the cartridge at a first rotational speed displaces the sample into the first temperature zone, and
wherein rotating the cartridge at a second rotational speed displaces the sample to the second temperature zone.

20. A system for testing a sample, the system comprising:
a rotatable cartridge, the rotatable cartridge comprising:
a sample reservoir located at a center of the rotatable cartridge;
a plurality of channels extending radially from the sample reservoir, wherein each of the plurality of channels is in fluidic communication with the sample reservoir;
a reagent reservoir comprising a first barrier is configured to separate the reagent reservoir from at least one channel of the plurality of the channels, and wherein displacement of the first barrier allows fluidic communication between the at least one channel and the reagent reservoir; and
a detection reservoir, comprising a second barrier separating the detection reservoir from the reagent reservoir, and wherein displacement of the second barrier allows fluidic communication between the reagent reservoir and the detection reservoir; and
an imaging device comprising:
an imaging sensor configured to capture one or more images of the sample in the detection reservoir; and
a computing device configured to analyze the captured one or more images.
